(19) United States
(12) Patent Application Publication
(10) Pub. No.: US 2011/0293343 A1
(43) Pub. Date: Dec. 1, 2011

(54) FUSING APPARATUS USED TO FUSE TONER IMAGE AND IMAGE FORMING APPARATUS

(75) Inventors: Masayuki SATOU, Toyohashi-shi (JP); Shoichi Yoshikawa, Okazaki-shi (JP); Shigeru Tashiro, Toyokawa-shi (JP); Noboru Oomoto, Toyokawa-shi (JP); Kuniya Matsuura, Toyohashi-shi (JP); Takayuki Ito, Nagoya-shi (JP)

(73) Assignee: Konica Minolta Business Technologies, Inc., Tokyo (JP)

(21) Appl. No.: 13/113,721

(22) Filed: May 23, 2011

(30) Foreign Application Priority Data
May 28, 2010 (JP) 2010-122638

(51) Int. Cl. G03G 15/20

(52) U.S. Cl. 399/333

(57) ABSTRACT

A fusing apparatus allows a recording member to pass through between a heat member and a pressure member, to transport and heat the recording member, and thereby fuses a toner image on the recording member. The heat member has a release layer, a low emissivity member, and an elastic layer. The release layer is formed on an outermost layer of the heat member. The low emissivity member is provided between the heat source and the release layer so as to abut on the release layer, and is made of a material with a lower emissivity than a material forming the release layer. The elastic layer is provided between the heat source and the low emissivity member. The release layer has infrared transmission properties at wavelengths of 2 to 10 μm.

This application is based on Japanese Patent Application No. 2010-122638 filed with the Japan Patent Office on May 28, 2010, the entire content of which is hereby incorporated by reference.

### BACKGROUND OF THE INVENTION

1. Field of the Invention

The present invention relates to a fusing apparatus, and more particularly to a fusing apparatus that fuses a toner image formed on a recording member, and an image forming apparatus including the fusing apparatus.

2. Description of the Related Art

In a fusing apparatus provided in an image forming apparatus, etc., a recording member having formed thereon a toner image is guided into the fusing apparatus, and the recording member passes through a region sandwiched between a fusing member and a heat member, whereby the toner image is heated and fused to the recording member.

Conventionally, in the fusing apparatus, in order to reduce the loss of heat radiated from the fusing member and the heat member, measures are taken, for example, to cover an area around the fusing member by a radiation reflector. However, the provision of the radiation reflector causes the inconvenience of increasing the size of the fusing apparatus.

To circumvent such an inconvenience, in Document 1 (Japanese Laid-Open Patent Publication No. 09-080952), a release layer is provided on a surface of a heat member. The release layer is made of a composite material in which PTFE (polytetrafluoroethylene) and PFA (tetrafluoroethylene-perfluoroalkylvinylether copolymer) are mixed with nickel which is a metal exhibiting excellent thermal conductivity, so that the emissivity in an infrared wavelength range corresponding to a fusing temperature in a fusing apparatus can be 0.65 or less. It is intended that by forming the release layer using such a material, the quantity of heat radiated from a surface of the heat member is suppressed.

However, according to a technique such as that described in the above Document 1, since the release layer is made of a composite material, a repetition of the passing of paper wears a surface of the release layer away. As a result, a metal basis material is exposed at the surface of the release layer and thus an event is expected that the release properties of the surface of the heat member decrease.

### SUMMARY OF THE INVENTION

The present invention is made in view of such circumstances, and an object of the present invention is therefore to suppress power consumption while suppressing a reduction in the release properties of a surface of a heat member in a fusing apparatus or an image forming apparatus.

A fusing apparatus according to one aspect of the present invention includes: a heat member including therein a heat source and having a cylindrical configuration; and a pressure member coming into contact with the heat member by pressure, and allows a recording member to pass through between the heat member and the pressure member, to transport and heat the recording member, and thereby fuses a toner image on the recording member. The heat member further includes: a release layer formed on an outermost layer of the cylindrical configuration; a low emissivity member provided between the heat source and the release layer so as to abut on the release layer, and made of a material with a lower emissivity than a material forming the release layer; and an elastic layer provided between the heat source and the low emissivity member. The release layer has infrared transmission properties at wavelengths of 2 to 10 μm.

A fusing apparatus according to another aspect of the present invention includes: a heat member including therein a heat source and having a cylindrical configuration; and a pressure member coming into contact with the heat member by pressure, and allows a recording member to be transported such that the recording member passes through between the heat member and the pressure member, to heat the recording member, and thereby fuses a toner image on the recording member. The heat member includes: a release layer formed on an outermost layer of the cylindrical configuration; and a cored bar provided between the heat source and the release layer so as to abut on the release layer, and made of a material with a lower emissivity than a material forming the release layer. The release layer is bonded to the cored bar by an adhesive member having infrared transmission properties at wavelengths of 2 to 10

An image forming apparatus according to the present invention includes a fusing apparatus such as those described above.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram describing a configuration of an image forming apparatus including a fusing apparatus according to an embodiment of the present invention.

FIG. 2 is a block diagram of the image forming apparatus in FIG. 1.

FIG. 3 is a diagram describing an internal configuration of the fusing apparatus in FIG. 1.

FIG. 4 is a perspective view of the fusing apparatus in FIG. 1.

FIG. 5 is a partial cutaway perspective view of a heat roller in FIG. 3.

FIG. 6 is a cross-sectional view of the heat roller in FIG. 5.

FIG. 7 is a diagram schematically showing a cross-sectional structure of the heat roller in FIG. 5.

FIG. 8 is a cross-sectional view of a first variant of the heat roller in FIG. 3.

FIG. 9 is a diagram schematically showing a cross-sectional structure of the heat roller in FIG. 8.

FIG. 10 is a diagram schematically showing a cross-sectional structure of a second variant of the heat roller in FIG. 3.

FIG. 11 is a diagram showing spectra of electromagnetic waves radiated by black bodies and a spectrum of the transmittance of PFA.

### DESCRIPTION OF THE PREFERRED EMBODIMENTS

An embodiment of the present invention will be described below with reference to the drawings. Note that in the drawings those components having the same functions are denoted by the same reference numerals and description thereof is not repeated.

In the present embodiment, as an example of an image forming apparatus, a tandem-type color printer that forms color images is shown. Note that an image forming apparatus according to the present invention may be of any type as long as the image forming apparatus includes a fusing apparatus, and thus may be a monochrome printer.

[1. Overall Configuration of an Image Forming Apparatus]

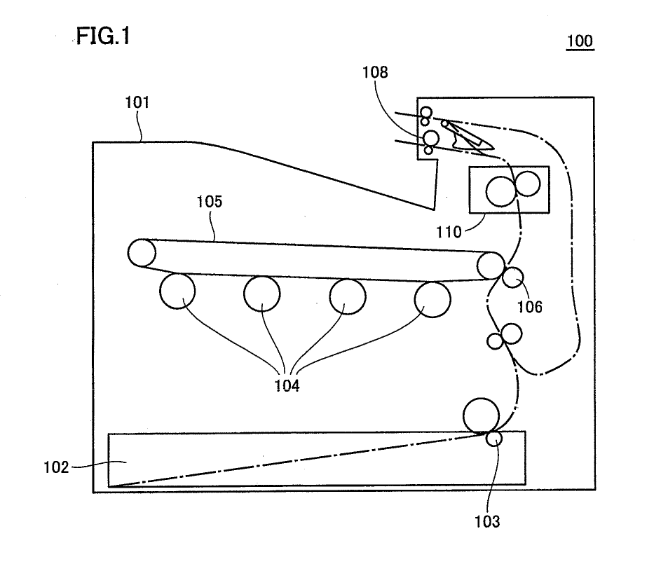

FIG. 1 is a diagram describing a configuration of an image forming apparatus including a fusing apparatus according to the present embodiment. With reference to FIG. 1, an image forming apparatus 100 has an outer cover 101 to cover the entire apparatus body. A recording member printed in the apparatus body is ejected from a discharge opening 108.

In image forming apparatus 100, there are shown four photoconductor units 104 that, for example, rotate for image formation; an intermediate transfer belt 105 that sequentially stacks toner images formed in the transfer positions of respective photoconductor units 104 and transfers the toner images; and a transfer roller 106 provided in a transfer position set around a moving surface of intermediate transfer belt 105.

Then, using paper feed rollers 103, a recording member stored in a paper feed cassette 102 is transported to the transfer position. Note that, though not shown, paper feed cassette 102 is provided with a sensor that detects whether there is a recording member. Thus, when paper feed cassette 102 is not set or when recording members run out, such an event is notified to a user by means of a display panel or the like, which is not shown.

In image forming apparatus 100, electrostatic latent images are formed on photoconductor units 104 based on image data to be printed on a recording member. Then, the electrostatic latent images formed on photoconductor units 104 are visualized with toner by development and are sequentially stacked on intermediate transfer belt 105. A toner image obtained as a result of electrostatic transfer onto intermediate transfer belt 105 and combining is electrostatically transferred onto a recording member at once in the transfer position by electrostatic suction by transfer roller 106. Then, the transferred paper (recording member) after the transfer is allowed to pass through a fusing apparatus 110, whereby heat and pressure are applied to fuse an image on the transferred paper. By this process, the image formation is completed. Thereafter, the recording member is discharged from discharge opening 108.

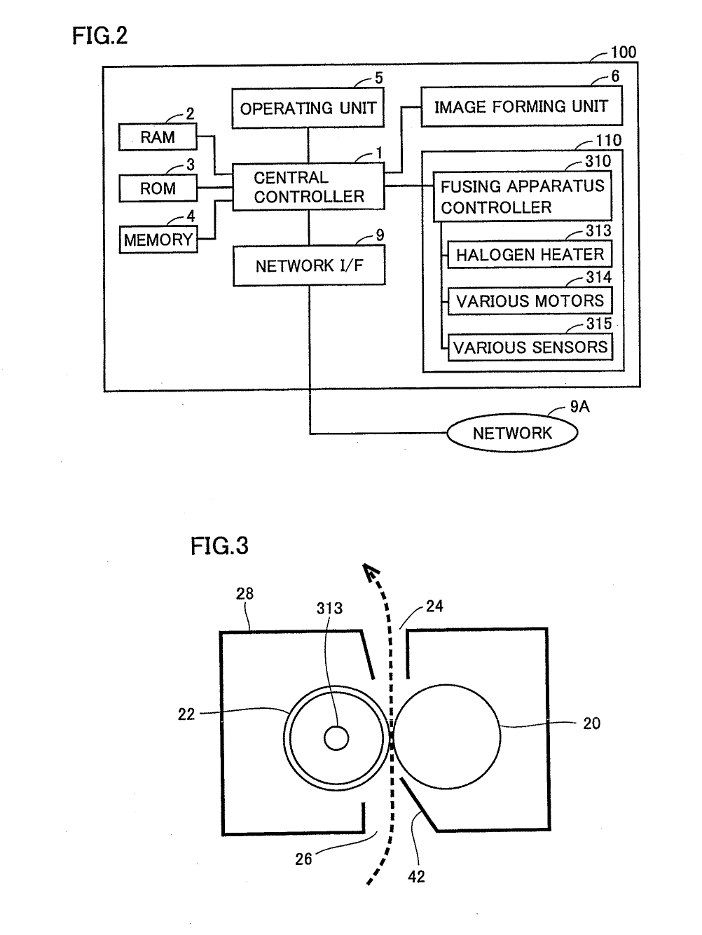

FIG. 2 is a block diagram of image forming apparatus 100.

With reference to FIG. 2, image forming apparatus 100 includes a central controller 1 that performs overall control of the operation of image forming apparatus 100. Central controller 1 includes a CPU (Central Processing Unit).

In addition, image forming apparatus 100 includes a ROM (Read Only Memory) 3 containing data such as programs executed by central controller 1; a RAM (Random Access Memory) 2 serving as a working area when central controller 1 executes a program; a memory 4 that stores various data such as set values used when central controller 1 executes a program; an operating unit 5 including a display unit that displays the state of image forming apparatus 100 and an input unit such as buttons used to input information externally; and a network I/F (interface) 9 serving as an interface when performing communication with an external device through a network 9A.

In image forming apparatus 100, an image formation operation includes formation of electrostatic latent images onto photoconductor units 104, rotation of intermediate transfer belt 105, rotation of transfer roller 106, rotation of paper feed rollers 103, a process for a sensor detection signal indicating whether there is a recording member in paper feed cassette 102, etc. In the image formation operation, an image forming unit 6 performs a process starting with formation and development of electrostatic latent images and then transferring of a toner image onto a recording member in paper feed cassette 102 up to guiding the recording member into fusing apparatus 110, and a process up to discharging of the recording member having passed through fusing apparatus 110 from discharge opening 108. The operation of image forming unit 6 is controlled by central controller 1.

Fusing apparatus 110 includes a fusing apparatus controller 310 that performs overall control of the operation of fusing apparatus 110. In fusing apparatus 110, fusing apparatus controller 310 controls the operations of a halogen heater 313 (heat source) and various motors 314 based on detection outputs from various sensors 315.

[2. Configuration of the Fusing Apparatus]

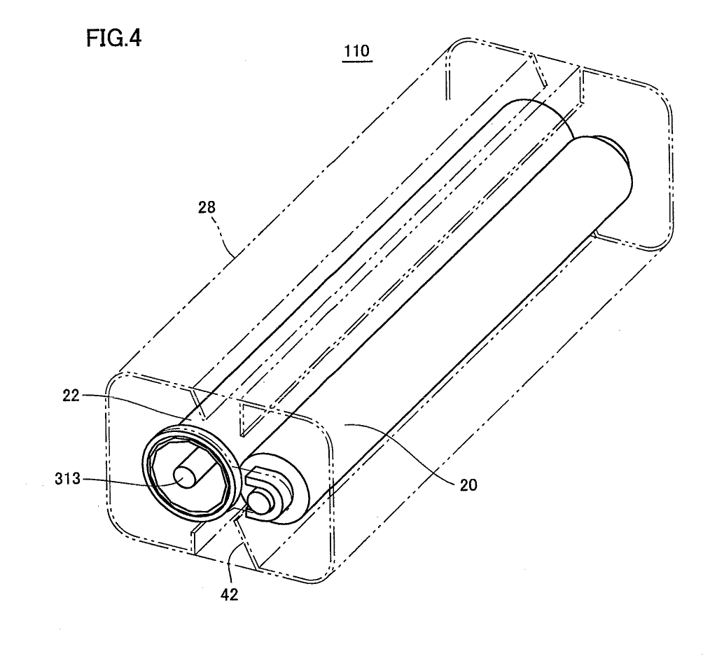

FIG. 3 is a diagram describing an internal configuration of fusing apparatus 110 according to the embodiment of the present invention. FIG. 4 is a perspective view of fusing apparatus 110.

With reference to FIGS. 3 and 4, fusing apparatus 110 includes a casing 28 covering the exterior thereof. In fusing apparatus 110, an eject opening 24 is provided on the top side of casing 28 (the downstream side in a transport direction of a recording member (paper)), and a loading opening 26 is provided on the bottom side which is the opposite side of the top side (the upstream side in the transport direction of the recording member).

Loading opening 26 is provided with a guide member 42. Note that, when guide member 42 is configured to be driven by a drive mechanism, loading opening 26 can also function as a shutter that opens and closes.

In casing 28 are provided a heat roller (heat member) 22 including halogen heater 313; and a pressure roller (pressure member) 20.

A recording member loaded through loading opening 26 on the bottom side of casing 28 is heated and pressurized by heat roller 22 and pressure roller 20. With this, a toner image on the recording member is fused to the recording member. Thereafter, the recording member is sent out of fusing apparatus 110 through discharge opening 24.

In fusing apparatus 110, a recording member comes into contact with heat roller 22 and pressure roller 20 by pressure so as to form a nip region. The nip region is formed such that clearance is not created in any other region than where the recording member is present, when the recording member passes therethrough.

With further reference to FIG. 2, fusing apparatus 110 includes a temperature sensor (not shown) that detects a surface temperature of heat roller 22 and that is included in various sensors 315 which will be described later. Fusing apparatus controller 310 controls the on and off of halogen heater 313 based on a temperature detected by the temperature sensor.

In addition, fusing apparatus controller 310 controls the drive of motors (not shown) that rotate heat roller 22 and pressure roller 20 and that are included in various motors 314, according to a timing at which a recording member is guided into fusing apparatus 110.

[3. Configuration of the Heat Roller]

(1) Overall Configuration of the Heat Roller

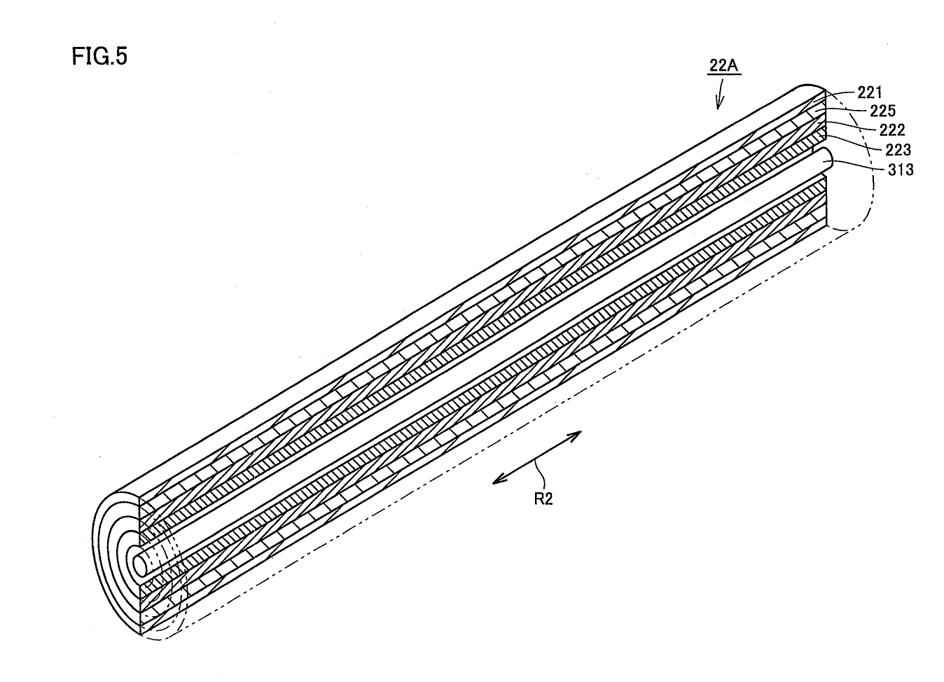

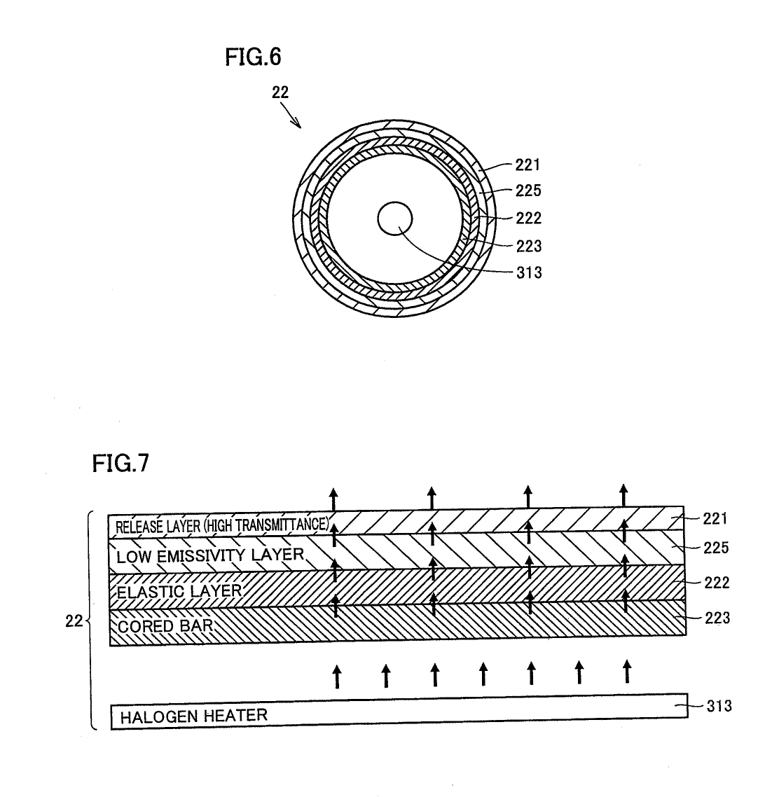

FIG. 5 is a partial cutaway perspective view of heat roller 22. FIG. 6 is a cross-sectional view of heat roller 22. FIG. 7 is a diagram schematically showing a cross-sectional structure of heat roller 22.

With reference to FIGS. 5 to 7, heat roller 22 has a cylindrical external configuration. Halogen heater 313 is provided inside the cylinder. A longitudinal direction of halogen heater 313 is along a longitudinal direction of heat roller 22 (double headed arrow R2).

A hollow cylindrical cored bar 223 is provided in heat roller 22 so as to include therein halogen heater 313. An elastic layer 222, a low emissivity layer 225, and a release layer 221 are provided in this order on an outer part of cored bar 223. Release layer 221 forms the outermost layer of heat roller 22.

Cored bar 223 is made of a material with excellent thermal conductivity properties, such as aluminum. Elastic layer 222 is made of heat resistant elastic rubber such as silicone rubber or fluorine rubber.

Low emissivity layer 225 is made of a material with a low emissivity, such as aluminum, copper, or silver. Note that the emissivity of low emissivity layer 225 is preferably on the order of 0.3 which is obtained when iron or the like is used, and is more preferably 0.1 or less which is obtained when the above-described aluminum, copper, silver, or the like, is used. Since the emissivity of low emissivity layer 225 decreases as a surface thereof is smoother, it is preferred that the surface of low emissivity layer 225 be mirror finished.

Release layer 221 is made of a material with a high transmittance in an infrared wavelength range of 2 to 10 μm. Examples of such a material include PFA (tetrafluoroethylene-perfluoroalkylvinylether copolymer) and PTFE (polytetrafluoroethylene). By forming release layer 221 using such materials, release layer 221 allows heat radiated from low emissivity layer 225 to be transmitted therethrough, thereby suppressing heat absorption (radiation) at release layer 221. Accordingly, energy is consumed only to melt toner by heat conduction, enabling to reduce wasteful energy release caused by radiation. In addition, according to the Lambert-Beer law, since the thinner the layer, the higher the transmittance, it is preferred that the film thickness be 30 μm or less.

Note that although a higher transmittance of release layer 221 in the above-described wavelength range is more preferable, it is sufficient that release layer 221 have infrared transmission properties at least in the above-described wavelength range.

Low emissivity layer 225 is formed by being coated on elastic layer 222 or release layer 221 by a technique such as plating, deposition, or thermal spraying. By thus forming low emissivity layer 225, the surface roughness of low emissivity layer 225 can be made smooth.

When low emissivity layer 225 is formed on elastic layer 222, low emissivity layer 225 needs to be bonded to release layer 221 in order for low emissivity layer 225 to be stably present in heat roller 22. For a mode of the bonding, for example, a bonding layer for bonding substantially the entire surface of low emissivity layer 225 to release layer 221 can be provided. As a bonding member, an adhesive or a primer is used that has infrared transmission properties in a wavelength range of 2 to 10 μm as does release layer 221. By using such an adhesive, radiation from the bonding layer can be suppressed.

Arrows in FIG. 7 schematically indicate the movement paths of heat emitted from halogen heater 313.

Heat (infrared rays) radiated from halogen heater 313 is transmitted in turn through cored bar 223, elastic layer 222, and low emissivity layer 225 by heat conduction. In heat roller 22, since release layer 221 having infrared transmission properties is provided on the outside of low emissivity layer 225, the higher the transmittance of release layer 221, the lower the amount of radiation from release layer 221 and the lower the amount of radiation from low emissivity layer 225 with respect to release layer 221. With this, wasteful consumption of heat transmitted to cored bar 223 from halogen heater 313 is suppressed at times other than during melting of toner on a recording member guided into fusing apparatus 110 (e.g., heat radiation radiated in air).

(2) Wavelength Characteristics of the Release Layer

For a material of release layer 221 in heat roller 22, a material is preferably used that has a high transmittance in an infrared wavelength range corresponding to a temperature range (about 150 to 200° C.; hereinafter, also referred to as the fusing control temperatures) where the surface of heat roller 22 is controlled for fusing of toner in fusing apparatus 110, whereby heat absorption and radiation are suppressed in the temperature range. Such a material is preferable because heat having reached release layer 221 is efficiently consumed only to melt toner on a recording member, avoiding a reduction in energy efficiency in fusing apparatus 110 as a result of wasteful radiation of the heat.

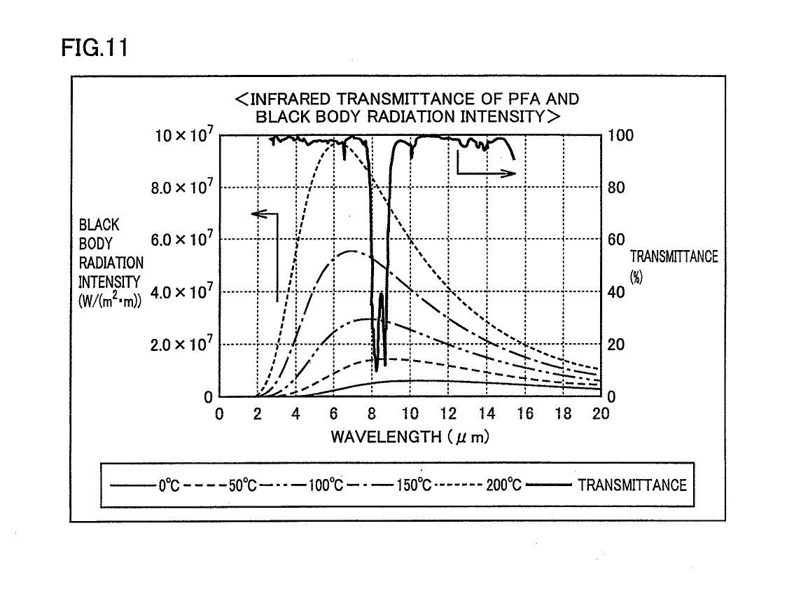

FIG. 11 shows spectra of electromagnetic waves radiated by black bodies at temperatures of 0° C., 50° C., 100° C., 150° C., and 200° C. and a spectrum of the transmittance of PFA which is an example of a fluorocarbon resin.

First, referring to the black body radiation spectra at the respective temperatures, in a temperature range shown in FIG. 11, the spectra at the respective temperatures have their peaks at around 2 to 8 μm, and as the temperature rises, the wavelength of the peak shifts more to the short wavelength side and the value of the peak increases more. In particular, at the fusing control temperatures, the radiation intensity is high at around 2 to 10 μm. Hence, it can be said that, for a material used for release layer 221, a material with a high transmittance in this wavelength range is preferable.

Although the transmittance of PFA locally exhibits a low value at around 8 it can be said that PFA generally has a high transmittance in a wavelength range where the black body radiation intensity is high at the fusing control temperatures. Therefore, it can be said that PFA is preferable as a material of release layer 221.

[4. First Variant of the Heat Roller]

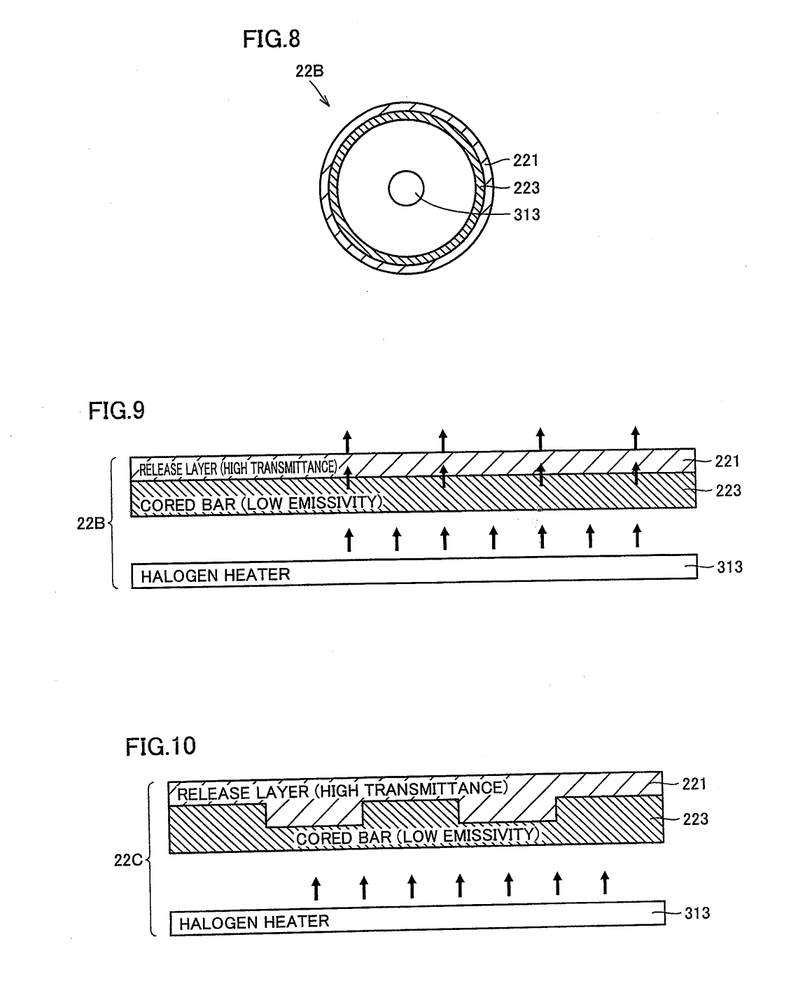

FIG. 8 is a cross-sectional view of a heat roller 22B which is a first variant of heat roller 22. FIG. 9 is a diagram schematically showing a cross-sectional structure of heat roller 22B.

With reference to FIGS. 8 and 9, heat roller 22B is of a different type than a type provided with elastic layer 222, such as heat roller 22. Heat roller 22B is of a type having a release layer 221 having infrared transmission properties in a wavelength range of 2 to 10 μm directly provided on a cored bar 223.

In heat roller 22B, cored bar 223 is formed of a low emissivity material. The surface roughness on the release layer side of cored bar 223 is, as an example, 0.5 μm or less at average surface roughness Ra, and the maximum height (Rmax) of cored bar 223 is made less than or equal to the film thickness of release layer 221, so as to prevent cored bar 223 from being exposed from a surface of release layer 221. Furthermore, since the smoother the surface, the lower the emissivity, it is preferred that the surface of cored bar 223 be mirror finished. Release layer 221 and cored bar 223 are bonded together by an adhesive. The adhesive has infrared transmission properties in a wavelength range of 2 to 10 μm, as does a material forming release layer 221.

[5. Second Variant of the Heat Roller]

FIG. 10 is a diagram schematically showing a cross-sectional structure of a heat roller 22C which is a second variant of heat roller 22.

Heat roller 22C includes a halogen heater 313 in a central portion thereof, as does heat roller 22, etc. In heat roller 22C, a cored bar 223 is provided so as to cover an outer part of halogen heater 313. A release layer 221 is provided on an outer surface of cored bar 223.

In heat roller 22C, the surface of cored bar 223 is provided with a projection and recess pattern configured not to cause a problem of an increase in emissivity, and a surface of release layer 221 facing cored bar 223 has a pattern fitting into the projection and recess pattern. In heat roller 22C, cored bar 223 and release layer 221 engage with each other by the fitting together of projections and recesses, whereby without bonding release layer 221 to cored bar 223 using an adhesive member, release layer 221 can be fixed to cored bar 223.

According to the present embodiment described above, in a fusing apparatus, a low emissivity member is provided to be closer to the heater side than a release layer and to abut on the releasing layer, and furthermore, the release layer has infrared transmission properties in a wavelength range of 2 to 10 μm, whereby wasteful heat loss at a surface of the release layer can be suppressed at times other than during fusing of toner by heating a recording member. With this, upon selecting a material forming the release layer, the necessity of considering a reduction in emissivity can be reduced, allowing more room for consideration of release properties.

Accordingly, a fusing apparatus according to the present embodiment and an image forming apparatus including the fusing apparatus can suppress power consumption while suppressing a reduction in the release properties of a surface of a heat member.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A fusing apparatus comprising: a heat member including therein a heat source and having a cylindrical configuration; and a pressure member coming into contact with said heat member by pressure, and allowing a recording member to pass through between said heat member and said pressure member, to transport and heat said recording member, and thereby fusing a toner image on said recording member, wherein
said heat member further includes:
a release layer formed on an outermost layer of said cylindrical configuration;
a low emissivity member provided between said heat source and said release layer so as to abut on the release layer, and made of a material with a lower emissivity than a material forming said release layer; and
an elastic layer provided between said heat source and said low emissivity member, and
said release layer has infrared transmission properties at wavelengths of 2 to 10 μm.

2. The fusing apparatus according to claim 1, wherein said low emissivity member is plated, deposited, or thermal sprayed onto a surface, that is on a side of said heat source, of said release layer.

3. The fusing apparatus according to claim 1, wherein said low emissivity member is bonded to said release layer by an adhesive member having infrared transmission properties at wavelengths of 2 to 10 μm.

4. A fusing apparatus comprising: a heat member including therein a heat source and having a cylindrical configuration; and a pressure member coming into contact with said heat member by pressure, and allowing a recording member to be transported such that said recording member passes through between said heat member and said pressure member, to heat said recording member, and thereby fuses a toner image on said recording member, wherein
said heat member includes:
a release layer formed on an outermost layer of said cylindrical configuration; and
a cored bar provided between said heat source and said release layer so as to abut on the release layer, and made of a material with a lower emissivity than a material forming said release layer, and
said release layer is bonded to said cored bar by an adhesive member having infrared transmission properties at wavelengths of 2 to 10 μm.

5. The fusing apparatus according to claim 4, wherein a surface roughness of said cored bar is configured such that a maximum height of a surface of the cored bar is less than or equal to a film thickness of said release layer.

6. An image forming apparatus that forms an image on a recording member, the image forming apparatus comprising:
a fusing apparatus according to claim 1.

7. An image forming apparatus that forms an image on a recording member, the image forming apparatus comprising:
a fusing apparatus according to claim 2.

8. An image forming apparatus that forms an image on a recording member, the image forming apparatus comprising:
a fusing apparatus according to claim 3.

9. An image forming apparatus that forms an image on a recording member, the image forming apparatus comprising:
a fusing apparatus according to claim 4.

10. An image forming apparatus that forms an image on a recording member, the image forming apparatus comprising:
a fusing apparatus according to claim 5.
